(19) United States
(12) Patent Application Publication
(10) Pub. No.: US 2007/0029532 A1
(43) Pub. Date: Feb. 8, 2007

(54) Flame retardant preparation

(76) Inventors: Jan-Gerd Hansel, Koln (DE); Ulrich Feldhues, Bergisch Gladbach (DE); Otto Mauerer, Leichlingen (DE)

Correspondence Address: LANXESS CORPORATION, 111 RIDC PARK WEST DRIVE, PITTSBURGH, PA, 15275-1112, US

(21) Appl. No.: 11/498,425

(22) Filed: Aug. 3, 2006

(30) Foreign Application Priority Data
Aug. 4, 2005 (DE) 10 2005 036 653.8

(51) Int. Cl. C09K 21/00

(52) U.S. Cl. 252/609

(57) ABSTRACT

The present invention relates to preparations composed of metal salts of organic phosphonic acids which feature high thermal stability, for use as flame retardants in engineering thermoplastics, and also to a process for preparation of these preparations.

The present invention relates to preparations composed of metal salts of organic phosphonic acids which feature high thermal stability, for use as flame retardants in engineering thermoplastics, and also to a process for preparation of these preparations.

### BACKGROUND OF THE INVENTION

Engineering thermoplastics from the polyester class, e.g. polybutylene terephthalate or polyethylene terephthalate, or from the polyamide class, e.g. nylon-6 or nylon-6,6, are widely used for applications in the automobile sector, in the construction sector and especially in the electrical and electronics sector. A frequent requirement in these applications is that the polymer preparations used are flame-retardant. The flame retardancy is achieved via incorporation of flame retardants into the thermoplastics. The incorporation process generally takes place during the compounding process, the untreated thermoplastic being heated until a liquid melt is formed and being mixed in the form of a melt with the flame retardants and if appropriate with other additives. The resultant compounding material can then be further processed via suitable processes, e.g. to give pellets. In the subsequent manufacture of mouldings, for example via extrusion or injection moulding, the compounding material is again processed in the form of a hot melt.

The compounding material is therefore exposed to high temperatures during the course of compounding and further processing. Unreinforced polybutylene terephthalate is processed at from 240 to 260° C. and glass fibre-reinforced polybutylene terephthalate is processed at from 250 to 270° C. Processing at from 280 to 285° C. is also possible in suitable mixers with relatively short residence times. Polyethylene terephthalate is processed at from 265 to 285° C. The melt temperatures during nylon-6 processing are from 260 to 270° C. and during nylon-6,6 processing are from 270 to 300° C. In particular in the case of reinforced thermoplastics, internal friction is likely to generate even higher peak temperatures. Details concerning this can be found by way of example in Kunststoff-Handbuch [Plastics Handbook], Ed. G. W. Becker, D. Braun, Volume III/I, pp. 46-47, 86-87, Hanser-Verlag, Munich 1992 and Volume III/4, p. 335, Hanser-Verlag, Munich 1998.

The flame retardants used are required to be capable of processing at these temperatures without any impairment of the flame-retardant thermoplastic preparation prepared therewith. When flame retardants are used in industry it is desirable to operate at maximum temperature because melt viscosity reduces as temperature rises, and this permits better mixing and higher throughput.

The prior art discloses flame retardants based on boron-containing substances, on nitrogen-containing substances, on phosphorus-containing substances, on chlorine-containing substances, on bromine-containing substances, on antimony-containing substances, on magnesium-containing substances or on aluminium-containing substances, for example in R. Gachter, H. Muller “Taschenbuch der Kunststoff-Additive” [Plastics Additives Handbook], Hanser-Verlag, Munich, Vienna, 3rd Edition 1990, pp. 768-770, E. D. Weil, S. V. Levchik, J. Fire Sci. 2004, 22, 251-264 and E. D. Weil, S. V. Levchik, J. Fire Sci. 2004, 22, 339-350.

In the relatively recent past, some of the chlorine- and bromine-containing flame retardants have been suspected of exerting harmful effects on humans and the environment. Their use in the electrical and electronics sector was consequently subjected to strict regulations in Europe, for example as documented in Directives 2002/95/EC (RoHS) and 2002/96/EC (WEEE).

EP 0 245 207 B1 (U.S. Pat. No. 4,972,011) describes halogen-free metal salts of organic phosphonic acids or of organic phosphonic monoesters as flame retardants. It says that flame-retardant polyamide preparations (EP 0 245 207 B1, Examples 29-31) and polyester preparations (EP 0 245 207 B1, Examples 32-34) can be prepared using these metal phosphonates, via compounding at 270° C.

However, decomposition phenomena are observed when using these metal phosphonates in the manner described in EP 0 245 207 B1 at temperatures above 270° C. The thermoplastic melt forms bubbles and solidifies to give brittle compositions which are unusable. This phenomenon can be attributed (see comparative examples) to the exothermic decomposition of the metal phosphonates at about 270° C., detectable via Differential Scanning Calorimetry (DSC). In the view of the abovementioned, conventional processing temperatures for polyesters and polyamides, the restriction of the processing temperature to at most 270° C. represents a considerable limitation on the applicability of these metals phosphonates.

An object of this invention is therefore to provide metal salts of organic phosphonic acids or of organic phosphonic monoesters whose thermal stability is improved over the prior art.

### SUMMARY OF THE INVENTION

Surprisingly, it has been found that the presence of small amounts of alkali metal compounds in preparations of metal phosphonates markedly increases their thermal stability in comparison with the thermal stability of the pure metal phosphonates.

This invention provides preparations comprising
(A) at least 90% of one or more metal salts of organic phosphonic acids or of organic phosphonic monoesters and
(B) at least one metal compound whose metal differs from that of component (A) and whose metal content is from 50 to 50 000 ppm, based on the entire preparation, the metal preferably having been selected from the group consisting of the alkali metals Li, Na and K.

The inventive preparations preferably comprise, as component (A), at least one metal salt of a phosphonic acid of the formula (I)

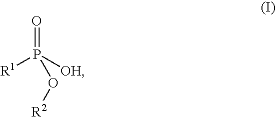

where
R¹ is a branched or unbranched alkyl radical having from 1 to 8 carbon atoms, particularly preferably an unbranched alkyl radical having from 1 to 4 carbon atoms, and
R² is hydrogen or a branched or unbranched alkyl radical having from 1 to 8 carbon atoms, particularly preferably an unbranched alkyl radical having from 1 to 4 carbon atoms.

The metal is preferably selected from the group consisting of Mg, Ca, Sr, Ba, B, Al, Ga, Si, Ge, Sn, Sb, Ti, Fe, Mn and Zn.

The phosphonic acid of the formula (I) is preferably methanephosphonic acid, monomethyl methanephosphonate, ethanephosphonic acid, monoethylethanephosphonate, propanephosphonic acid, monomethylpropanephosphonate, 1-methylpropanephosphonic acid, monomethyl 1-methylpropanephosphonate, 2-methylpropanephosphonic acid, monomethyl 2-methylpropane-phosphonate, n-butanephosphonic acid or monomethyl n-butanephosphonate.

Component (A) particularly preferably comprises aluminium tris(monomethyl methanephosphonate), calcium methanephosphonate, zinc methanephosphonate, aluminium tris(monomethyl propanephosphonate), calcium propanephosphonate and/or zinc propanephosphonate.

The metal compounds present as component (B) are preferably salts of the alkali metals Li, Na and/or K. These salts can, by way of example, be the anhydrous or hydrated fluorides, chlorides, bromides, sulphates, phosphates, pyrophosphates, carbonates, silicates, borates or aluminates of the alkali metals Li, Na and/or K. Mixtures of these salts can also be present as component (B). Component (B) is particularly preferably sodium compounds.

The metal content of component (B) is preferably from 100 to 10 000 ppm, particularly preferably from 500 to 5000 ppm, based on the entire preparation.

The inventive preparations can be prepared by known methods, for example from the known metal phosphonates and alkali metal compounds. They are preferably prepared by the preparation process described below.

In one preferred embodiment, the inventive preparations comprise from 90.0 to 99.9% of component (A), particularly preferably from 90.1 to 99.5% of component (A).

This invention therefore also provides a process for preparation of preparations comprising
(A) at least 90% of one or more metal salts of organic phosphonic acids or of organic phosphonic monoesters and
(B) at least one metal compound whose metal differs from that of component (A) and whose metal content is from 50 to 50 000 ppm, based on the entire preparation, the metal preferably having been selected from the group consisting of the alkali metals Li, Na and K,
   characterized in that an aqueous solution of strength at least 30% of a lithium, sodium and/or potassium salt of a phosphonic acid or of a phosphonic monoester is reacted with an aqueous solution or suspension of a metal salt and the solid that precipitates is isolated.

It is preferable to use the aqueous solution of a lithium, sodium and/or potassium salt of a phosphonic acid of the formula (I) 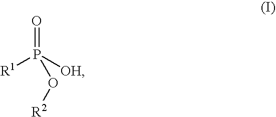
where
R¹ is a branched or unbranched alkyl radical having from 1 to 8 carbon atoms, particularly preferably an unbranched alkyl radical having from 1 to 4 carbon atoms, and
R² is hydrogen or a branched or unbranched alkyl radical having from 1 to 8 carbon atoms, particularly preferably an unbranched alkyl radical having from 1 to 4 carbon atoms.

It is particularly preferable to use the aqueous solution of a lithium, sodium and/or potassium salt of methanephosphonic acid, of monomethyl methanephosphonate, of ethanephosphonic acid, of monoethylethanephosphonate, of propanephosphonic acid, of monomethylpropanephosphonate, of 1-methylpropanephosphonic acid, of monomethyl 1-methylpropanephosphonate, of 2-methyl-propanephosphonic acid, of monomethyl 2-methylpropanephosphonate, of n-butanephosphonic acid or of monomethyl n-butanephosphonate.

It is very particularly preferable to use the sodium salts of the abovementioned phosphonic acids or phosphonic monoesters.

The metal salt is preferably selected from the group consisting of the at least to some extent water-soluble salts of Mg, Ca, Sr, Ba, B, Al, Ga, Si, Ge, Sn, Sb, Ti, Fe, Mn and Zn. The at least to some extent water-soluble salts of the abovementioned metals can by way of example be the anhydrous or hydrated metal chlorides, metal nitrates, metal sulphates, metal hydroxides or metal oxides.

The metal salt is particularly preferably an anhydrous or hydrated aluminium chloride, aluminium nitrate, aluminium sulphate, aluminium hydroxide, zinc chloride, zinc nitrate, zinc sulphate, zinc oxide, calcium chloride, calcium nitrate or calcium hydroxide or a mixture of these salts.

The process is preferably carried out at temperatures of from 10 to 95° C., particularly preferably from 15 to 80° C.

The strength of the aqueous solution of the lithium, sodium and/or potassium salt of a phosphonic acid or of a phosphonic monoester is preferably at least 35%. All of the % data in the present description are % by weight.

The abovementioned preference ranges are applicable in relation to the mixing ratio of component (A) and (B) during the preparation of the inventive preparations.

The inventive process can be carried out in conventional reaction vessels, batchwise or continuously. The reactants are preferably intimately mixed with one another during the reaction. The solid can be isolated via conventional separation methods, for example via filtration, sedimentation or centrifuging. The solid is preferably isolated via filtration. The isolated solid can be further purified, for example via washing. The isolation of the solid preferably includes drying as final step in the process. To this end, use can be made of conventional driers. It is also possible to isolate the solid via spray drying.

The inventive preparations or the preparations obtainable via the inventive process feature increased thermal stability. They are therefore more suitable than preparations known from the prior art for use alone or in combination with other flame retardants for providing flame retardancy to engineering thermoplastics. In particular, they are more suitable for use in engineering thermoplastics, e.g. polyesters or polyamides, if appropriate in combination with other flame retardants, such as melamine, melamine derivatives, metal hydroxides or inorganic phosphates as flame retardants or antidripping agents.

The present invention also provides the use of the inventive preparations as flame retardants, preferably in engineering thermoplastics which comprise at least one polyester or comprise at least one polyamide, particularly preferably polybutylene terephthalate, polyethylene terephthalate, or polyamides, in particular nylon-6 and nylon-6,6.

The present invention further provides mouldings obtainable via extrusion or injection moulding of the abovementioned engineering thermoplastics comprising the inventive preparations, and also provides a process for modification of those engineering thermoplastics with flame retardants, characterized in that the inventive preparations are used.

Finally, the present invention provides mouldings comprising engineering thermoplastics modified with the inventive preparations as flame retardants, and also provides the use of the inventive preparations for production of flame-retardant engineering thermoplastics or flame-retardant mouldings, in particular in the electrical and electronics industry.

Another aspect of the present invention is combination of the inventive preparations with other flame retardants as antidripping agents.

The invention is further illustrated by the examples below, but there is no intention that these restrict the invention.

### EXAMPLES

The stated parts are based on weight.

### Comparative Example C1

### (According to EP 0 245 207 B1, Example 9)

53.4 parts of anhydrous aluminium chloride were added in portions, with stirring, to 304 parts of dimethyl propanephosphonate. This formed a suspension of a white solid, which was diluted with 152 parts of dimethylpropanephosphonate. Once the addition of aluminium chloride had ended, the mixture was heat-conditioned at 140° C. for 2 h. Finally, the mixture was cooled to room temperature, diluted with 316 parts of acetone and filtered, and then washed three times with 80 parts of acetone. 172.6 parts of white solid remained after drying at 120° C. and 100 mbar.

Elemental analysis for C₁₂H₃₀AlO₉P₃:

| | | | |
|---|---|---|---|
| Calculated: | C 32.9% | H 6.9% | Na 0.0 ppm |
| Found: | C 33.0% | H 6.9% | Na <0.1 ppm |

IR (KBr): 2961 s, 2875 m, 2851 m, 1467 m, 1408 w, 1379 w, 1346 m, 1250 s, 1177 s, 1109 s, 1058 s, 1034 s, 906 w, 846 s, 817 s, 758 m, 717 w, 601 m, 483 s cm⁻¹.

### Comparative Example C2

2069 parts of a 47.8% strength, aqueous solution of technical aluminium sulphate hydrate (17% Al₂O₃) were added dropwise to 5490 parts of a 26.2% strength, aqueous solution of the sodium salt of monomethyl propanephosphonate at 80° C., with stirring, within a period of 1 h. Stirring was continued at 80° C. for 1.5 h, and the mixture was cooled to 30° C., subjected to suction filtration and washed with 2700 parts of water. 1236.7 parts of white solid remained after drying at 120° C. and 100 mbar.

Elemental analysis for C₁₂H₃₀AlO₉P₃:

| | | | |
|---|---|---|---|
| Calculated: | C 32.9% | H 6.9% | Na 0 ppm |
| Found: | C 32.9% | H 6.8% | Na 20 ppm |

IR (KBr): 2963 s, 2876 m, 2852 m, 1468 m, 1409 w, 1379 w, 1347 m, 1251 s, 1177 s, 1108 s, 1056 s, 1034 s, 906 w, 846 s, 816 s, 758 m, 717 w, 602 m, 482 s cm⁻¹.

### Inventive Example 1

575 parts of a 47.8% strength, aqueous solution of technical aluminium sulphate hydrate (17% Al₂O₃) were added dropwise to 1030 parts of a 38.8% strength solution of the sodium salt of monomethyl propanephosphonate at 25° C., with stirring, within a period of 1 h. Stirring was continued for 2 h, and the mixture was subjected to suction filtration and washed with 2 000 parts of water. 301.2 parts of white solid remained after drying at 120° C. and 100 mbar.

Elemental analysis for C₁₂H₃₀AlO₉P₃:

| | | | |
|---|---|---|---|
| Calculated: | C 32.9% | H 6.9% | Na 0 ppm |
| Found: | C 32.8% | H 6.7% | Na 780 ppm |

IR (KBr): 2963 s, 2875 m, 2852 m, 1468 m, 1408 w, 1379 w, 1346 m, 1251 s, 1177 s, 1108 s, 1056 s, 1034 s, 904 w, 846 s, 816 s, 758 m, 717 w, 602 m, 481 s cm⁻¹.

### Inventive Example 2

1030 parts of a 38.8% strength solution of the sodium salt of monomethyl propanephosphonate and 575 parts of a 47.8% strength, aqueous solution of technical aluminium sulphate hydrate (17% Al₂O₃) were simultaneously added dropwise at 25° C., with stirring, to 50 parts of water within a period of 1 h. Stirring was continued for 2 h, and the mixture was subjected to suction filtration and washed with 3000 parts of water in two portions. 289.7 parts of white solid remained after drying at 120° C. and 100 mbar.

Elemental analysis for C₁₂H₃₀AlO₉P₃:

| | | | |
|---|---|---|---|
| Calculated: | C 32.9% | H 6.9% | Na 0 ppm |
| Found: | C 32.6% | H 6.7% | Na 640 ppm |

IR (KBr): 2962 s, 2876 m, 2852 m, 1468 m, 1409 w, 1379 w, 1347 m, 1252 s, 1177 s, 1108 s, 1056 s, 1034 s, 906 w, 846 s, 816 s, 758 m, 717 w, 602 m, 482 s cm⁻¹.

Thermal Stability

The thermal stability of the metal phosphonate preparations from the non-inventive comparative examples and from the inventive examples was studied by means of DSC. Here, specimens of about 10 mg were heated in air in an open crucible at a heating rate of 10° C./min, from 20° C. to 450° C. The decomposition temperature stated in the table for each specimen is the peak temperature of the first exothermic peak.

TABLE
Sodium contents and thermal stabilities in non-inventive Comparative
Examples C1 and C2 and in Inventive Examples 1 and 2

| | Na content, | Decomposition |
|---|---|---|
| Example | ppm | temperature ° C. |
| C1 | <0.1 | 275 |
| C2 | 20 | 270 |
| 1 | 780 | 286 |
| 2 | 640 | 289 |

Results

The aluminium tris(monomethyl propanephosphonate) is known from EP 0 245 207 B1, Example 9, and was prepared as main component in Comparative Examples C1 and C2 and in Inventive Examples 1 and 2. The infrared (IR) spectra of all of the specimens prepared exhibited no significant differences. This shows that the main component of the specimens is identical, irrespective of the process. The results of C,H elemental analyses agree within a limit of accuracy of 0.3% with the values calculated for pure aluminium tris(monomethyl propanephosphonate).

Comparative Examples C1 and C2 show that, irrespective of the method of preparation, a decomposition temperature of from 270 to 275° C. can be observed when sodium content in the metal phosphonate is low.

Inventive Examples 1 and 2 show that use of a concentrated solution of the sodium salt of monomethyl propanephosphonate gives products with increased sodium content. These products feature a decomposition temperature above 285°, thus, when compared with the prior art, increasing the possible processing temperatures for engineering thermoplastics by more than 10° C.

What is claimed is:

1. A preparation comprising
(A) at least 90% of one or more metal salts of organic phosphonic acids or of organic phosphonic monoesters and
(B) at least one metal compound whose metal differs from that of component (A) and whose metal content is from 50 to 50 000 ppm, based on the entire preparation, the metal preferably having been selected from the group consisting of the alkali metals Li, Na and K.

2. A preparation according to claim 1, wherein component (A) is a metal salt of a phosphonic acid of the formula (I) 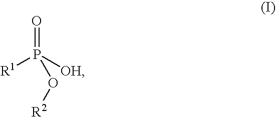
where
R¹ is a branched or unbranched alkyl radical having from 1 to 8 carbon atoms, and
R² is hydrogen or a branched or unbranched alkyl radical having from 1 to 8 carbon 1 5 atoms.

3. A preparation according to claim 2, wherein component (A) is a metal salt of methanephosphonic acid, of monomethyl methanephosphonate, of ethanephosphonic acid, of monoethylethanephosphonate, of propanephosphonic acid, of monomethyl-propanephosphonate, of 1-methylpropanephosphonic acid, of monomethyl 1-methylpropanephosphonate, of 2-methylpropanephosphonic acid, of monomethyl 2-methylpropanephosphonate, of n-butanephosphonic acid or of monomethyl n-butanephosphonate.

4. A preparation according claim 2, wherein the metal present in the metal salt of component (A) has been selected from the group consisting of Mg, Ca, Sr, Ba, B, Al, Ga, Si, Ge, Sn, Sb, Ti, Fe, Mn and Zn.

5. A preparation according to at least one of claims 1 to 4, wherein component (A) comprises aluminium tris(monomethyl methanephosphonate), calcium methanephosphonate, zinc methanephosphonate, aluminium tris(monomethyl propanephosphonate), calcium propanephosphonate and/or zinc propanephosphonate.

6. A method of use of the preparations according to claims 1 to 5 as flame retardants.

7. A method of use of the preparations according to claims 1 to 5 as flame retardants for engineering thermoplastics which comprise at least one polyester or comprise at least one polyamide.

8. A method of use of the preparations according to claims 1 to 5 alone or in combinations with other flame retardants as antidripping agent.

9. A process for preparation of preparations comprising
(A) at least 90% of one or more metal salts of organic phosphonic acids or of organic phosphonic monoesters and
(B) at least one metal compound whose metal differs from that of component (A) and whose metal content is from 50 to 50 000 ppm, based on the entire preparation, the metal preferably having been selected from the group consisting of the alkali metals Li, Na and K,
wherein an aqueous solution of strength at least 30% of a lithium, sodium and/or potassium salt of a phosphonic acid or of a phosphonic monoester is reacted with an aqueous solution or suspension of a metal salt and the solid that precipitates is isolated.

10. A moulding comprising engineering thermoplastics modified with the preparations according to claims 1 to 5 as flame retardants.

11. A method of use of the moulding according to claim 10 in the electrical and electronics industry.

12. A process for production of mouldings via extrusion or injection moulding of engineering thermoplastics modified with the preparations according to claims 1 to 5.
